(19) United States
(12) Patent Application Publication
(10) Pub. No.: US 2008/0029926 A1
(43) Pub. Date: Feb. 7, 2008

(54) Compound of Wood and Synthetic Material

(76) Inventors: Martin Steinwender, Perchtoldsdorf (AT); Peter Schubert, Polten (AT); Norbert Mundigler, Tulln (AT); Hannes Frech, Kapelln (AT)

Correspondence Address: Prokauer Rose;Patent Department, 1585 Broadway, New York, NY, 10036, US

(21) Appl. No.: 10/574,161

(22) PCT Filed: Oct. 1, 2004
(86) PCT No.: PCT/EP04/10952

§ 371 Date: Feb. 6, 2007

(30) Foreign Application Priority Data
Oct. 1, 2003 (DE) 103 46 120.5

(51) Int. Cl. B29C 47/00

(52) U.S. Cl. 264/176.1; 156/244.11; 428/480

(57) ABSTRACT

The invention relates to a compound of a thermoplastic synthetic material and a strengthening components whereby the technical problem of indicating a high-grade compound work material at low production cost, in particular for outdoor application has been solved in that the thermoplastic synthetic material is a synthetic polyester, preferably a polyethylene terephthalate (PET), and the strengthening components is an organic filler, preferably fine-particle wood or wood fibers. The invention also relates to the production of structural parts from the component as well as the structural parts themselves.

### BACKGROUND

The present invention relates to a compound as well as to a process for the production of the compound 1 comprising a composite material of wood and synthetic material also called a wood-plastic compound (WPC).

The compound material of synthetic materials and wood material and processes for its production by extrusion or injection molding is known. Such products have found indoor and outdoor applications for many years.

The bases of such compounds are synthetic materials such as polyethylene (PE), high-density polyethylene (HDPE), polypropylene (PP), polystyrol (PS), polycarbonate (PC) or polyvinyl chloride (PVC). These possess rheological characteristics making it possible to keep the temperature relatively low, between 130 and 180° C. during the joint processing with the wood. This is necessary to avoid as much as possible thermal damage to the wood.

The wood has the task of strengthening the synthetic material or to function as filler without continued negative influence due to water action on the synthetic-material characteristics with respect to dimensional stability. This is especially important for outdoor applications so as to obtain a dimensionally stable material. Fine-particle wood, wood in fiber form or even wood flour can be used as the wood. The sieve fraction distribution characterized in Table I shows a conventional wood mixture:

TABLE 1

| GRAIN SIZE | PERCENTAGE OF MASS |
|---|---|
| MM | % |
| X > 1.400 | 2.6 |
| 1.400 > X > 1.000 | 11.5-11.8 |
| 1.000 > X > 0.710 | 21.2 |
| 0.710 > X > 0.500 | 23.2 |
| 0.500 > X 0.400 | 9.2 |
| 0.400 > X > 0.315 | 11.8 |
| 0.350 > X > 0.250 | 7.2 |
| 0.250 > X > 0.125 | 7.8 |
| X > 0.125 | 5.1 |
| TOTAL | 100.0 |

The mixing ratio between synthetic material and wood lies between 70:30 and 20:80 percents in weight. The wood material used can be e.g. specially prepared wood in form of wood flour or flour-like or pressed into wood pellets.

The disadvantage of such compounds is on the one hand the low heat resistance caused by the relatively low melting temperature of the synthetic materials and the high price.

The technical object of the present invention is to present a high-quality compound material at low production costs. This compound material should be especially well used for outdoor applications.

In order to achieve this technical objective a synthetic polyester, in particular polyethylene terephthalate (PET) is used as the synthetic material, and the wood material used is the type used e.g. in the production of chip boards or fiber boards.

PET purchased new is more expensive than the synthetic materials used according to the state of the art. For this reason waste from synthetic material collection is used since PET is much used as a packing material for foodstuff. A large share is contained in non-returnable bottles collected after one-time use and being used again for the production of PET bottles after suitable processing. Cleaning is however very expensive and can hardly compete with new material. Especially dyed bottles or even fillers such as are used for non-transparent bottles cause problems in particular. In addition the labels (e.g. made of paper and attached to the bottle with suitable adhesives) and the threaded seals must be removed. None of this cumbersome cleaning is required for the compound according to the invention.

It has furthermore been shown to be advantageous if an inorganic filler is provided and admixed to the compound. Different materials can be used as the inorganic filler: talc, chalk, titan oxide, brick dust and inorganic dyes such as iron oxide. The advantages of these inorganic fillers are improved moisture resistance, increased specific weight and the fact that the compound can be colored in a specific manner by the additives.

Other substances to be used as additives are those making it possible to achieve special characteristics. Thus an addition of the substances known from synthetic material production can influence electrical conductivity (e.g. through graphite or expansion graphite), the UV resistance, aging behavior, odor, the ability to be bonded, welded, chipped, fire resistance (e.g. through expansion graphite, phosphorus combinations or borate).

The addition of chemically or physically acting foaming agents can furthermore strongly influence porosity and thereby many other physical characteristics, mainly however thermal characteristics. As an example of a physically acting foaming agent water, and as an example of a chemically acting foaming agent azo foaming agents should be mentioned.

The mixing ratio between wood and synthetic polyester that has proven itself lies between 30:70 and 70:30. The mixing ratio lies advantageously between 60:40 and 30:70, preferably between 50:50 and 30:70. A compound produced from this surpasses other wood-synthetic material compounds through high flexural resistance and through low water absorption. The greater the share in synthetic polyester, the better are these characteristics.

The extrusion of a rope-like structural parts as well as injection molding technology for spherical, high-precision structural parts with little tolerance are suitable processes for the production of a structural part that consists at least in part of a previously described compound.

As is customary with purely synthetic-material mixtures, a calendaring device or a double band press can be installed downstream of the extruder for the production of board-shaped products in order to achieve improved distribution of the compound and thereby greater measuring accuracy, improved surface quality and reduced internal stress of the work pieces.

An upgrading of the structural part consisting of the wood-synthetic material compound can mainly be achieved through the different coating possibilities.

Thus it was shown that while striving for the least possible water absorption, the wood-PET compound is also suitable for lamination, i.e. it can serve as a support for laminates and impregnators, for other types of foils e.g. of metal, for cardboard, for leather, for linoleum, for cork or for wood, in particular veneer, etc. Depending on their behavior with regard to moisture, water-less adhesive systems may be required. They can be applied according to processes known from the state of the art, continuously or in short cycles.

The good heat resistance of PET, and with suitable adjustment of the electrical conductivity, possibly through the addition of graphite, excellent suitability for powder coating is afforded.

Similarly, coating can be applied in liquid form, e.g. in form of a color or lacquer coat or an artificial resin coating.

### SUMMARY OF THE INVENTION

The compound of the type described earlier can be processed e.g. to become board-shaped structural parts, in particular as wall covering, ceiling covering or floor covering. In this case the compound provides especially great advantages for the utilization in wet areas, since it offers for the first time an economic possibility to produce a material with any kind of covering. Ceramic coverings for example, which are customarily used for this, cannot, be provided with printed decorations.

In addition to special requirements in interior construction, these can however also be met in outdoor areas, advantageously mainly wherever decorative design, weather resistance and at the same good strength characteristics are needed.

Depending on the application it may be advisable to provide suitable border profiles at the edges of the boards. These can be formed at the same time with the production or, as with conventional board materials, also through subsequent, mostly chipping processing. Using suitable foaming agents can produce very strong board materials with advantageous thermal properties.

A multitude of different profiles can be produced with rope-like products, with the advantages over conventional wood-synthetic material profiles of greater temperature resistance, better fire resistance and without igniting dripping in case of fire. Profiles for window and door frame parts can be foamed and produced advantageously in the core, thereby achieving excellent insulating characteristics and at the same time making it possible to insert screws at any location for very strong connections such as are necessary with the great weight of the parts. For assembled frame construction it is of course possible to make only one frame part with the compound according to the invention, so that it would be possible, for example, to provide a wooden frame on the side towards the room and cover the outside with a profile made of weather resistant compound.

### DETAILED DESCRIPTION OF THE INVENTION

Especially with rope-shaped products designed for outdoor use it man be advisable to apply a coating of synthetic material by means of co-extrusion. It is thus possible to produce improved weather protection.

### EXAMPLE

Wood with a characteristic sieve curve as in table 1 is mixed with PET flakes. The wood originates in an industrial production line for chipboards and is not processed especially. Moisture is around 2%. The PET flakes come from shredded PET bottle material. Labels, seals and residual pollution from food (soft drinks) were not removed. The mixing ratios of wood and PET were 50:50 9HP 03), 40:60 (HP02) and 30:70 (HP 01).

From the mixture an extruder produced a granulate having a medium to dark brown color. From the granulate thus obtained board-shaped injection molded parts (approximately 15×15×0.5 cm³) were produced, and these had the following characteristics after storage in normal climate (23° C., 5% relative humidity) for 14 days:

TABLE 2

| Recipe | HP 01 | HP 02 | HP 03 |
|---|---|---|---|
| Flexural strength | 64.24 | 85.53 | 92.37 |
| [N/mm2] | | | |
| Impact strength | 4.549 | 5.323 | 5.550 |
| [kJ/m²] | | | |
| Density | 1.345 | 1.356 | .345 |
| [g/cm³] | | | |
| 2 h water swelling¹ | 0.3 | 0.4 | 0.4 |
| [%] | | | |
| 24 h water swelling¹ | 0.5 | 0.7 | 0.9 |
| [%] | | | |
| 2 h Flushing agent² | 0.4 | 0.2 | 0.5 |
| solution [%] | | | |
| 24 h Flushing agent² | 0.6 | 0.5 | 1.0 |
| solution [%] | | | |
| Remarks | Wood/PET | Wood/PET | Wood/PET |
| | 30/70% per weight | 40/60% per weight | 50/50% per weight |

¹Swelling behavior when stored in water for 2 h and 24 h, as well as with
²Storage in 20 g flushing agent solution for 1 liter water;
Flushing agent: BULSAN soap cleanser.

In addition, samples of the recipe HP 03 were subjected to artificial weathering according to Table 3 and edge swelling was examined in accordance with EN 13329.

The effects of artificial weathering on the mechanical characteristics are shown in Table 4

TABLE 3
Cycles of artificial weathering:

| Step | Function | Temperature | Duration | |
|---|---|---|---|---|
| 1 | Condensation | 45° | 24 | h |
| 2 | Below-cycle step | | 48 | x |
| | 3 + 4 | | | |
| 3 | UV illumination | 60° | 2.5 | h |
| 4 | Spraying phase | | 0.5 | h |
| 5 | Start with step 1 | | | |

Explanations/Technical Data:
The temperature during the UV illumination phase was 60° C.
The temperature during the condensation phase is 45° C.
The illumination strength of the UV lamps is 0.77 W/m².
The spraying of the samples during the spray phase (rain) is at normal water temperature.
Total duration per cycle: 168 h
Total duration: 2016 h (12 weeks) with 12 times repetition of the cycle.

TABLE 4
Changes in flexural resistance and impact strength
after 400 h, 1000 h, and 2016 h artificial weathering

| Recipe | HP 03 |
|---|---|
| Flexural resistance after 400 h | 8% |
| Flexural resistance after 1000 h | 13% |
| Flexural resistance after 2016 h | 18% |
| Impact strength after 400 h | No significant connection |
| Impact strength after 1000 h | No significant connection |
| Impact strength after 2016 h | No significant connection |

Swelling of the HP 03 mixture (50% wood/50% PET) at the edges as measured according to EN 13329 resulted in values below 2%.

1. Compound of a thermoplastic synthetic material and a strengthening component, wherein the thermoplastic component is synthetic polyester and the strengthening component organic filler.

2. Compound as in claim 1, wherein the thermoplastic component is polyethylene terephthalate (PET.

3. Compound as in claim 1, wherein the organic strengthening components fine-particle wood or wood fibers.

4. Compound as in claim 1, wherein the PET is waste from the collection of used PET products, in particular from the collection of packing material.

5. Compound as in claim 1, wherein an inorganic filler is provided.

6. Compound as in claim 5, wherein the inorganic filler is provided to influence the moisture resistance and/or the specific weight and/or for coloring.

7. Compound as in claim 1, wherein an additive is provided to influence electric conductivity, UV resistance, aging behavior, odor, coatability, bondability, weldability, chipability and/or fire resistance.

8. Compound as in claim 1 wherein an organic or physical foaming agent is provided to influence porosity and/or thermal characteristics.

9. Compound as in claim 1, wherein the mixing ratio between wood and synthetic polyester lies within the range from 7:30 to 30:70, in particular from 60:40 to 30:70, and preferably from 50:50 and 30:70.

10. Process for the production of a structural part from a compound as in claim 1, wherein the compound is produced through thermoplastic conversion, preferably through extrusion or injection molding.

11. Process as in claim 10, wherein a board-shaped structural part is produced.

12. Process as in claim 11, wherein the structural part is postprocessed by means of a calendaring device or double band press downstream of the extruder.

13. Process as in claim 10, wherein a rope-shaped structural part is produced.

14. Process as in claim 10, wherein at least one surface of the structural part is provided with a coating.

15. Process as in claim 14, wherein the surface is laminated with a laminate, an impregnator, a foil, in particular metal foil, with cardboard, with leather, with linoleum, with cork or with wood, in particular veneer.

16. Process as in claim 14, wherein the surface is coated with a powder coating.

17. Process as in claim 14, wherein the coating is applied in liquid form.

18. Process as in claim 14, wherein a color coating, lacquer or artificial resin is used as the liquid coating.

19. Process as in claim 14, wherein a coating of synthetic material is applied by means of co-extrusion.

20. Structural part consisting at least in part of a compound as in claim 1.

21. Structural part as in claim 20, wherein the structural part has been produced by means of a process according to claim 10.

22. Structural part as in claim 20, wherein the structural part is used as wall, ceiling or floor covering.

23. Structural part as in claim 20, wherein the structural part is used as a profile, in particular elements of window frames or door frames.

24. Structural part as in claim 20, wherein at least one surface of the structural part is provided with a coating.

25. Structural part as in claim 20, wherein swelling when stored in water for over 2 hours is less than 0.5% and less than 1.0% at 24 hours and more.

26. Structural part as in claim 20, wherein the change in flexural resistance of the structural part is less than 10% and in particular 8% with artificial weathering for over 400 hours.

27. Structural part as in claim 20, wherein the change in flexural resistance of the structural part is less than 15% and in particular 13% with artificial weathering for over 1000 hours.

28. Structural part as in claim 20, wherein the change in flexural resistance of the structural part is less than 20% and in particular 18% with artificial weathering for over 2016 hours.

29. Structural part as in claim 20, wherein the swelling at the edges is less than 2% as measured according to EN 13329.
